(19) United States
(12) Patent Application Publication
(10) Pub. No.: US 2013/0067424 A1
(43) Pub. Date: Mar. 14, 2013

(54) LIFE PREDICTION METHOD OF ELECTRONIC DEVICE AND DESIGN METHOD OF ELECTRONIC DEVICE USING THE METHOD

(71) Applicants: Kenichi YAMAMOTO, Kanagawa (JP); Ryosuke Kimoto, Kanagawa (JP); Kenya Kawano, Hitachinaka (JP); Hisashi Tanie, Mito (JP); Yasuhiro Naka, Hitachinaka (JP)

(72) Inventors: Kenichi YAMAMOTO, Kanagawa (JP); Ryosuke Kimoto, Kanagawa (JP); Kenya Kawano, Hitachinaka (JP); Hisashi Tanie, Mito (JP); Yasuhiro Naka, Hitachinaka (JP)

(73) Assignee: RENESAS ELECTRONICS CORPORATION

(21) Appl. No.: 13/593,499

(22) Filed: Aug. 23, 2012

(30) Foreign Application Priority Data
Sep. 9, 2011 (JP) 2011-196711

(51) Int. Cl. G06F 19/00; G06F 17/50

(52) U.S. Cl. 716/110; 702/34

(57) ABSTRACT

A life prediction method of an electronic device in which the life prediction accuracy is more improved than that in a related art technique, and a design method of an electronic device based on the above method, are established. Life prediction is performed by incorporating either of a change in a physical property of a solder joint portion and a change in the fatigue life of a solder, the changes occurring when left at a high temperature. The change in a physical property of the solder joint portion or the change in the fatigue life of the solder is determined from the relationship between a heat treatment temperature and a heat treatment time. These changes are then formulated to be incorporated into the life prediction.

### CROSS-REFERENCE TO RELATED APPLICATIONS

The disclosure of Japanese Patent Application No. 2011-196711, filed on Sep. 9, 2011 including the specification, drawings and abstract is incorporated herein by reference in its entirety.

### BACKGROUND

The present invention relates to a life prediction method of an electronic component, such as a semiconductor device, and is an effective technology when applied to, for example, a life prediction method of a solder joint portion and to a design method of an electronic component, such as a semiconductor device, using the above method.

Life predictions of solder ball (bump) joint portions in BGA (Ball Grid Array)-type semiconductor devices have been studied, as described in Japanese Unexamined Patent Publication No. 2000-304630 and Japanese Unexamined Patent Publication No. 2006-313800.

In addition, a method as described in Japanese Unexamined Patent Publication No. 2007-108843 has also been studied as a design support method of a semiconductor device.

In Japanese Unexamined Patent Publication No. 2000-304630, a two-dimensional model is set to calculate a plastic strain by a finite element method based on this model, and the fatigue life of a solder joint portion is predicted based on the relationship with the results of actual temperature cycle tests.

In Japanese Unexamined Patent Publication No. 2006-313800, the fatigue life of a semiconductor device is predicted, based on the dimensions and physical properties of amounting structure of the semiconductor device, by a simplified equation for calculating a strain in a solder portion, by which a damage in the solder joint portion is estimated.

In Japanese Unexamined Patent Publication No. 2007-108843, a statistical model in relation to a failure occurrence mechanism is specified by using CAE (Computer Aided Engineering) data and the data stored by actual measurement as total data.

### SUMMARY

In the aforementioned related art (Japanese Unexamined Patent Publication No. 2000-304630), sufficient prediction accuracy cannot be obtained in designing a product. The life prediction by a simulation with the use of a finite element method, such as in the related art (Japanese Unexamined Patent Publication No. 2000-304630), is not accurate life prediction.

Other challenges and new features will become apparent from the description in the specification and accompanying drawings.

Of the means for solving the challenges disclosed in the present application, the outline of a typical means is briefly described as follows:

That is, in a method according to one embodiment, life prediction is performed by incorporating either a change in the physical property of a solder joint portion or a change in the fatigue life of solder into the life prediction.

According to an embodiment disclosed in the present application, accuracy in predicting the life of an electronic device can be improved.

### BRIEF DESCRIPTION OF THE DRAWINGS

FIGS. 1A and 1B are views illustrating a test specimen for creating and evaluating a fatigue life curve according to an embodiment;

FIG. 2 is a table showing heat treatment conditions under which the test specimen in FIG. 1 is treated;

FIG. 3 is a view illustrating a method of providing a displacement with the test specimen in FIG. 1 being fixed;

FIG. 4 is a graph showing fatigue life curves obtained at a heat treatment temperature of 125° C. according to the embodiment;

FIG. 5 is a graph showing fatigue life curves obtained at a heat treatment temperature of 150° C. according to the embodiment;

FIG. 6 is a graph showing fatigue life curves obtained at a heat treatment temperature of 175° C. according to the embodiment;

FIG. 7 is a graph showing changes in the decreasing rate of fatigue life depending on heat treatment times according to the embodiment;

FIG. 8 is a graph showing the temperature dependence of each of a saturation coefficient (S) and an acceleration factor (D) according to the embodiment;

FIG. 9 is a view illustrating the shape of a test specimen used in formulating physical properties, such as a yield stress, according to the embodiment;

FIG. 10 is a table showing heat treatment conditions under which the test specimen illustrated in FIG. 9 is treated;

FIG. 11 is a graph showing the results of stress-strain diagram measurement obtained by using the test specimen in FIG. 9;

FIG. 12 is a graph showing dependence of the decreasing rate of yield stress (γ_{YD}) on a heat treatment time and a heat treatment temperature according to the embodiment;

FIG. 13 is a graph showing the temperature dependence of a decreasing rate coefficient of yield stress according to the embodiment;

FIG. 14 is a graph showing the temperature dependence of the yield stress according to the embodiment;

FIG. 15 is a graph showing the temperature dependence of Young's modulus according to the embodiment;

FIG. 16 is a graph showing the temperature dependence of a work-hardening rate according to the embodiment;

FIG. 17 is a life prediction flow diagram showing a life prediction method using a change in a solder physical property according to the embodiment;

FIGS. 18A to 18C are outline views of a semiconductor package that is a simulation model according to the embodiment;

FIG. 19 is a cross-sectional structure view of the simulation model, the view illustrating part of the cross-section in a state where the semiconductor package illustrated in FIGS. 18A to 18C has been mounted on an evaluation board;

FIG. 20 is an enlarged cross-sectional structure view of the area A enclosed by a solid line in the simulation model illustrated in FIG. 19;

FIG. 21 is a table showing temperature cycle test conditions under which the simulation models illustrated in FIGS. 18A to 18C, 19, and 20 are treated;

FIG. 22 is a table showing the yield stresses of Sn-3Ag-0.5Cu of the simulation models illustrated in FIGS. 18A to 18C, 19, and 20;

FIG. 23 is a table showing the Young's modulus and work-hardening rate of Sn-3Ag-0.5Cu of the simulation model according to the embodiment;

FIG. 24 is a table showing the physical properties of the materials of the simulation model according to the embodiment, other than Sn-3Ag-0.5Cu;

FIG. 25 is a table showing temperature cycle test conditions for verification according to the embodiment;

FIG. 26 is a graph showing Weibull plots of the results of the temperature cycle tests shown in FIG. 25;

FIG. 27 is a table showing an average life in each of the test conditions (A model, B model, C model) shown in FIG. 25;

FIG. 28 is a graph showing comparisons among the fatigue life in the temperature cycle test, the predicted life according to the embodiment, and the predicted, life according to a related art, of Sn-3Ag-0.5Cu of the simulation model;

FIG. 29 is a life prediction flow diagram showing a life prediction method using a change in the fatigue life according to the embodiment;

FIG. 30 is a new design flow diagram showing design steps according to the embodiment; and

FIG. 31 is a design flow diagram showing design steps in a related art.

### DETAILED DESCRIPTION

### 1. Outline of Embodiment

Outline of a typical embodiment disclosed in the present application will be first described: (a) degradation behaviors of a fatigue life, occurring due to being left at a high temperature, are evaluated by experiments such that a fatigue life curve at any temperature and after any time is formulated (by using the Coffin-Manson rule); (b) similarly, degradation behaviors of the yield stress, occurring due to being left at a high temperature, are also evaluated by experiments such that a prediction equation at any temperature and after any time is created (formulated); (c) a change in an equivalent plastic strain range generated in a solder is calculated by a simulation with the use of both the above formula in (b) and a finite element method; (d) the change in the equivalent plastic strain range (change in a physical property) or a change in a fatigue ductility coefficient (change in the fatigue life) is approximated by a function such that a damage rate after any cycles is calculated by using the formula in (a); and (e) a life is predicted by using a linear cumulative damage rule.

### 2. Details of Embodiment

If needed for convenience, the following embodiment will be described by dividing it into multiple sections; however, the multiple sections are not irrelevant to each other, but they are in a relationship in which one is a variation, application example, detailed description, or supplementary description of part or the whole of the others, unless otherwise indicated. Also, when the number of elements, etc., (including the number of pieces, numeric value, amount, and range, etc.) is mentioned in the following embodiment, the number thereof should not be limited to the specific number, but may be a number larger than or equal to or smaller than or equal to the specific number, unless otherwise indicated or clearly limited to the specific number in principle.

Further, in the following embodiment, the constituents (also including element steps, etc.) are not necessarily essential, unless otherwise indicated or clearly essential in principle. Likewise, when the shapes or positional relationships of the constituents are mentioned in the following embodiment, shapes, etc., substantially approximate or similar to the above shapes, etc., are to be included, unless otherwise indicated or clearly considered otherwise in principle. The same is true with the aforementioned number, etc., (including the number of pieces, numeric value, amount, and range, etc.).

In the whole views for explaining the following embodiment, members or parts having the same function as each other will be denoted with the same or relevant reference numeral and duplicative description will be omitted. In the following embodiment, the description of the same or similar member or part will not be repeated in principle, unless particularly needed.

### EMBODIMENT

Hereinafter, a life prediction method of a solder joint portion in a semiconductor device according to the present embodiment and a design method of a semiconductor device using the above method will be described in detail with reference to accompanying drawings.

### (A) Formulation of Fatigue Life Curve

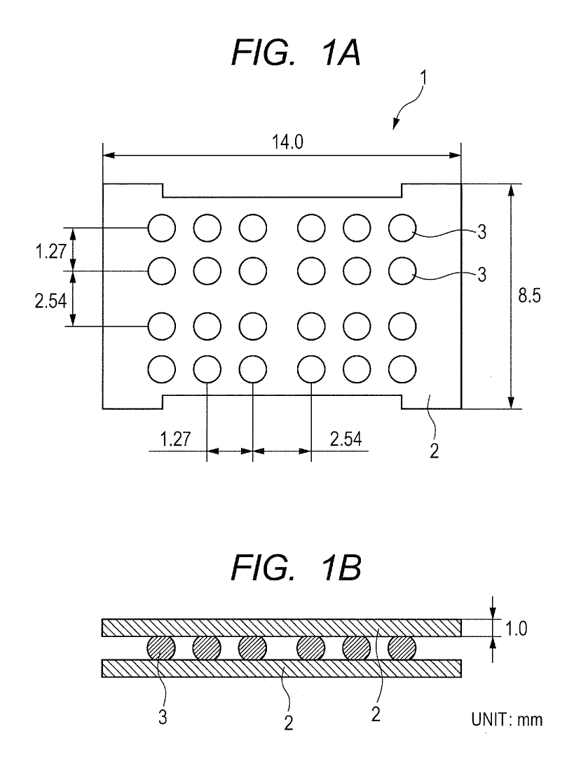

A test specimen 1 for creating and evaluating a fatigue life curve is illustrated in FIGS. 1A and 1B, in which FIG. 1A is a view (plan view) illustrating the plane of the test specimen 1 and FIG. 1B is a view (cross-sectional view) illustrating the cross-section of the test specimen. The test specimen had a structure simulating a BGA-type semiconductor device, in which 24 solder balls 3 were sandwiched by FR-4 substrates 2 each having a thickness of 1 mm. The solder used had a composition of lead-free Sn-3Ag-0.5Cu, and the ball diameter was made to be Φ0.6 mm, and the coupling diameter between the ball and the substrate 2 was made to be Φ0.5 mm.

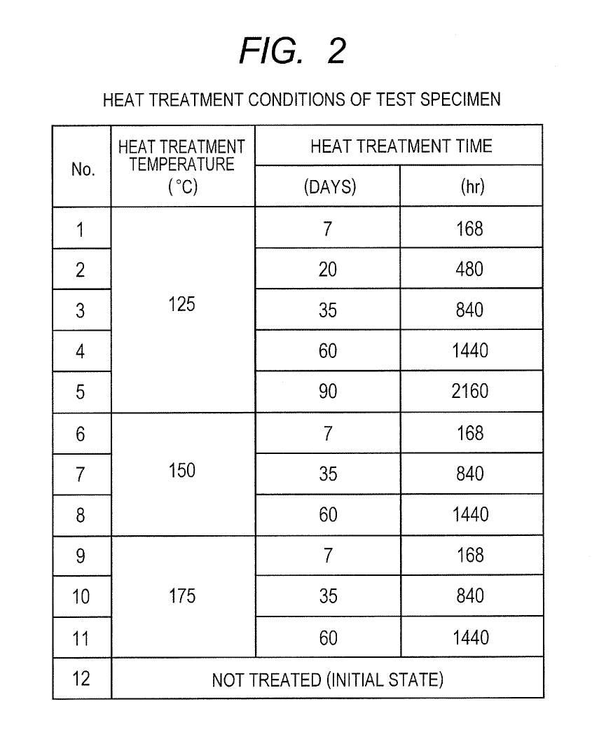

Heat treatment conditions under which the studied test specimen 1 is treated are shown in FIG. 2. Heat treatment temperatures were set to be 125° C., 150° C., and 175° C., taking into consideration the operating temperature (environmental temperature) equivalent to that in an engine room. In determining heat treatment times, 35 days that is equivalent to 1000 times of the temperature cycle tests was first selected and 7 days and 60 days were added, centered on 35 days. In the case of 125° C., 20 days and 90 days were further added in order to study in more detail. Also, the test specimen 1 in the initial state, which was not subjected to the heat treatment, was prepared.

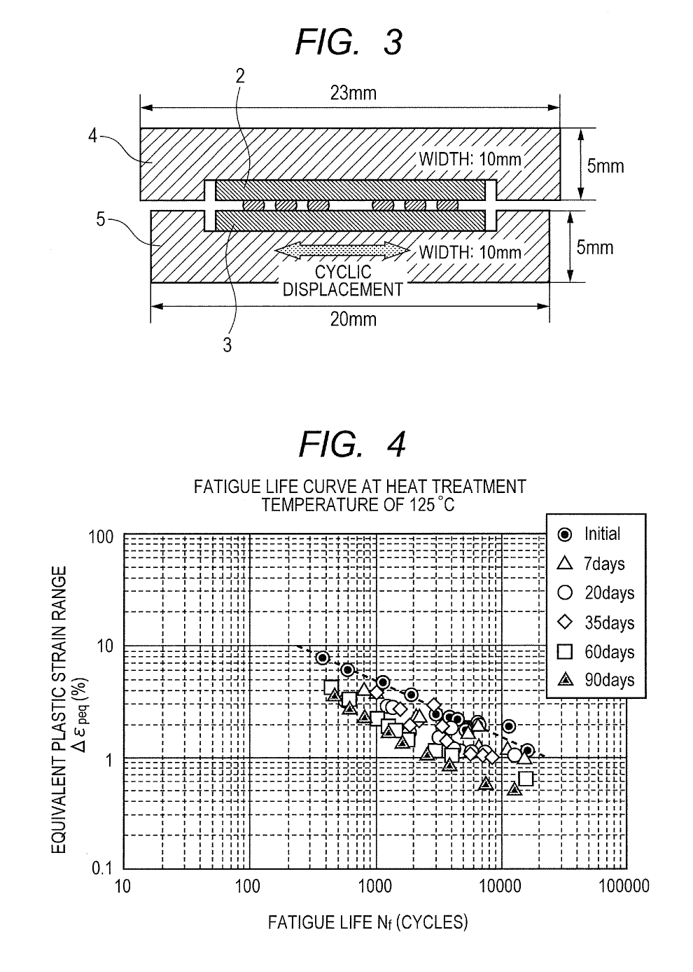

As illustrated in FIG. 3, the test was performed as follows: each of the aforementioned test specimens 1, including those subjected to the heat treatment and that not subjected thereto, was fixed by the upper substrate 2 of the test specimen 1 being fixed to an upper jig 4; and a displacement was cyclically provided, by a lower jig 5, to the lower substrate 3 in the shear direction (direction indicated by the arrow in FIG. 3). The test temperature was set to be room temperature (23° C.), the test frequency to be 1 Hz, and the number of tests per one condition to be 10.

The relationship between a displacement amount and a life is evaluated by the test specimen 1. Tests are performed by changing the displacement amount. An equivalent plastic strain generated in a solder bump (solder ball) is calculated by a finite element method at each time when the displacement amount is changed. An equivalent plastic strain range Δε, which is an equivalent plastic strain amount increased when a displacement has been provided, is calculated.

Fatigue life curves, obtained when the heat treatment temperature is 125° C., are shown in FIG. 4. The heat treatment times are the initial time, 7 days, 20 days, 35 days, 60 days, and 90 days, as shown on the right side of the graph.

The vertical axis represents the equivalent plastic strain range (ε) generated in a bump and the horizontal axis represents a life, i.e., the number of cycles (Nf) until the fatigue life. It can be known that, when the heat treatment time becomes long at the heat treatment temperature of 125° C., the fatigue life tends to be decreased (if the equivalent plastic strain range is the same, the number of cycles until the fatigue life is decreased).

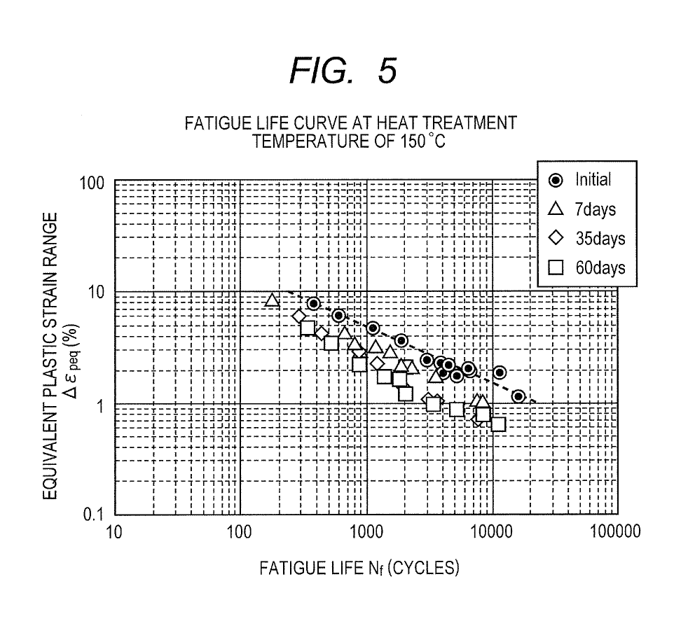

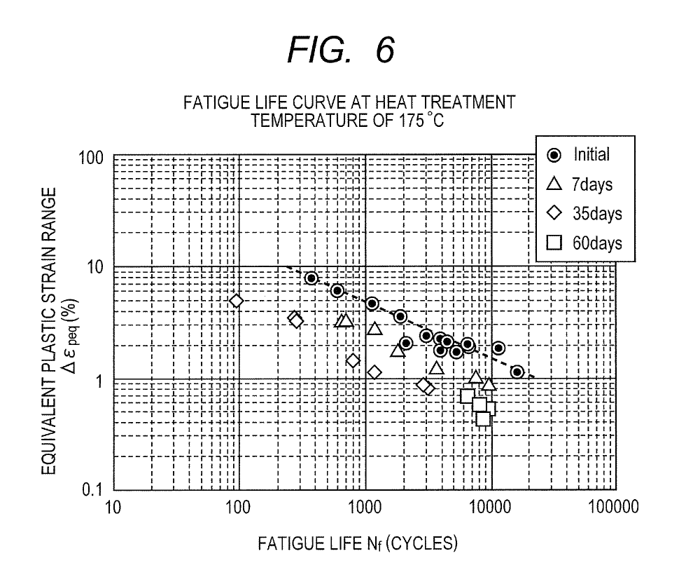

Subsequently, fatigue life curves, obtained when the heat treatment temperatures are 150° C. and 175° C., are shown in FIGS. 5 and 6, respectively. Similarly to FIG. 4, it can be known that, when the heat treatment time becomes long, the fatigue life is decreased.

The fatigue life curve can be represented by the following equation (1) (Coffin-Manson rule).

$${N}_{f} = ( {Δɛ}_{peq} / {C}_{p} ) - \frac{1}{{a}_{p}} \qquad [ Equation 1 ]$$

where, N_{f}; fatigue life (times), Δε_{peq}; equivalent plastic strain range, Cₚ; fatigue ductility coefficient, aₚ; fatigue ductility index (=0.5)

Subsequently, a change in a fatigue ductility coefficient (Cp) is defined by the equation (2) as a decreasing rate of fatigue life (γ_{SD}).

$${r}_{SD} = \frac{{C}_{p 0} - {C}_{p 1}}{{C}_{p 0}} \qquad [ Equation 2 ]$$

where γ_{SD}); decreasing rate of fatigue life, Cₚ₀; initial fatigue ductility coefficient (=1.21), Cₚ₁; fatigue ductility coefficient after heat treatment

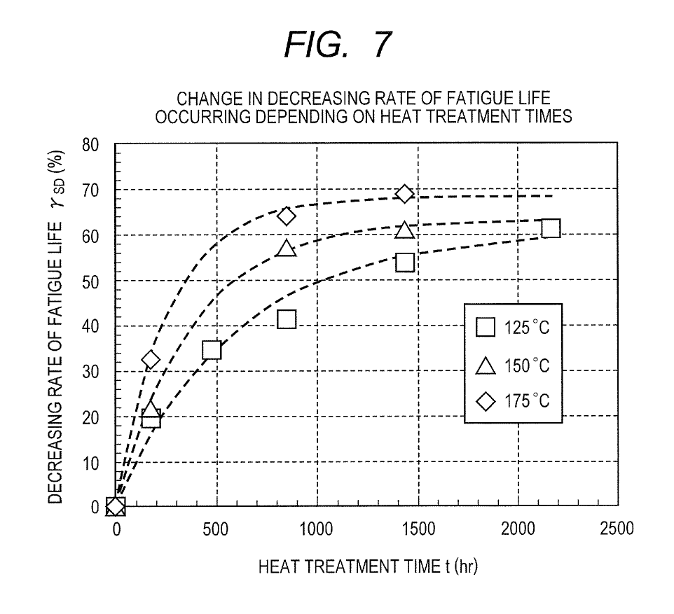

Changes in the decreasing rate of fatigue life (γ_{SD}), occurring depending on heat treatment times, are shown in FIG. 7. As known from FIG. 7, the decreasing rate of fatigue life (γ_{SD}) becomes larger at each temperature as the heat treatment time is longer, the decreasing rate of fatigue life being saturated at 60 to 70%.

In order to formulate the above degradation behaviors, the correlation among the decreasing rate of fatigue life (γ_{SD}), the heat treatment temperature, and the heat treatment time is defined as a function in a form like the equation (3).

The “e” is an exponential (hereinafter, it is the same).

r_{SD}=S(1−e^{-D·t}) [Equation 3]

where S; saturation coefficient of decrease in life, D; acceleration factor of decrease in life, t; heat treatment time

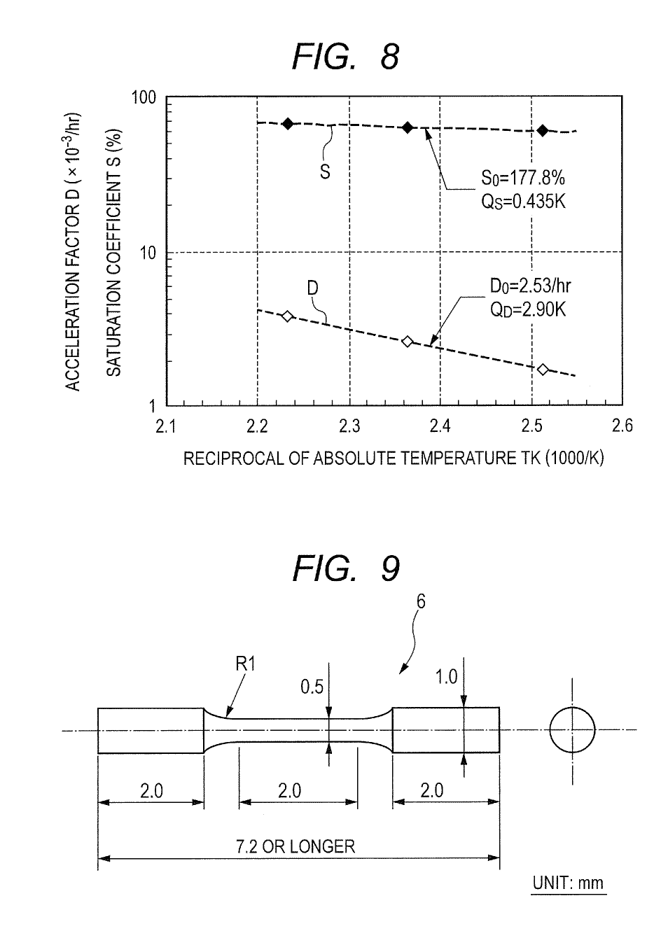

The temperature dependence of each of the saturation coefficient (S) and the acceleration factor (D) in the equation (3) is shown in FIG. 8.

In addition, the saturation coefficient (S) has been formulated with the following equation (4).

S=S₀·e^{-Q}^{_{S}}^{·T}^{_{K}} [Equation 4]

where S; saturation coefficient, S₀; vibration factor, Q_{S}; Arrhenius parameter, T_{K}; inverse of absolute temperature

Further, the acceleration factor (D) has been formulated with the following equation (5).

D=D₀·e^{-Q}^{_{D}}^{·T}^{_{K}} [Equation 5]

where D; acceleration factor, D₀; vibration factor, Q_{D}; Arrhenius parameter, T_{K}; inverse of absolute temperature

From what have been described above, a fatigue life curve at any heat treatment temperature and after any heat treatment time can be obtained by using the formulated equations (1) to (5).

### (B) Formulation of Yield Stress and Other Properties

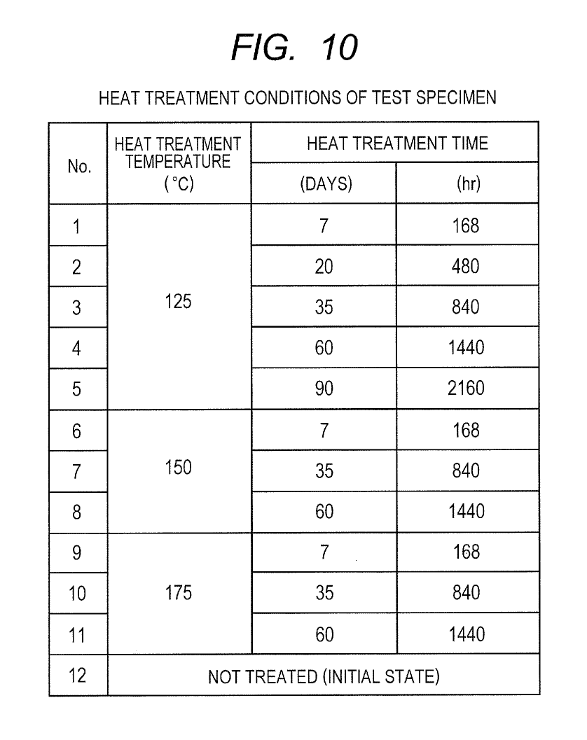

A test specimen 6 for measuring a decreasing rate of yield stress is illustrated in FIG. 9. In this test specimen 6, the diameter of the central fracture section is 0.5 mm that is similar to the coupling diameter of the BGA solder ball (bump). The distance between the evaluation points in the central section is 2 mm and the dimensions of the attachment section (both end sections) that are to be attached to a test machine are Φ1 mm×2 mm. The solder used has a composition of lead-free Sn-3Ag-0.5Cu and the heat treatment conditions (high-temperature holding conditions) are shown in FIG. 10.

Heat treatment temperatures were set to be 125° C., 150° C., and 175° C. In determining heat treatment times, 35 days that is equivalent to 1000 times of the temperature cycle tests in each of which the heat treatment time (holding time) is 20 minutes per one cycle was first selected and 7 days and 60 days were added, centered on 35 days. In the case of 125° C., 20 days and 90 days were further added in order to study in more detail. Also, the test specimen in the initial state, which was not subjected to the heat treatment, was prepared as a comparison.

The measured temperature was set to be room temperature (23° C.) and the strain speed to be 1.0%/sec, and a tension displacement was applied before the strain range reached 10% or the test specimen was fractured.

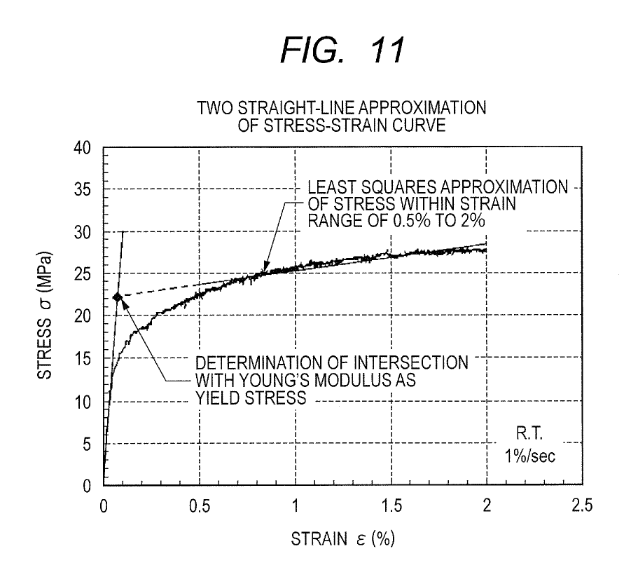

FIG. 11 shows an example of the results of stress-strain diagram measurement when the test specimen 6 has not been subjected to the heat treatment (initial state). In FIG. 11, approximation was carried out with two straight lines. The stress within the strain range of 0.5 to 2% was subjected to straight-line approximation (least squares approximation) such that the intersection with the Young's modulus was determined as a yield stress. This two straight-line model can be represented by the equations (6) and (7) (modeling with two straight-line approximation).

σ=σ_{y}+Kεₚ [Equation 6]

where σ; stress, σ_{y}; yield stress, K; work-hardening rate, εₚ; plastic strain, E; Young's modulus, ε; strain

σ=E(ε−εₚ) [Equation 7]

where σ; stress, σ_{y}; yield stress, K; work-hardening rate, εₚ; plastic strain, E; Young's modulus, ε; strain

Subsequently, degradation behaviors of the yield stress were studied by creating a stress-strain diagram (not illustrated) in each of the three conditions under which the test specimen 6 was subjected to heat treatment at each of temperatures of 125° C., 150° C., and 175° C. The temperature at which the stress-strain diagram was measured was set to be room temperature (23° C.) in the same way as described above. The strain speed was set to be 1.0%/sec and a tension displacement was applied before the strain range reached 10% or the test specimen was fractured.

A decreasing rate of yield stress (γ_{YD}) is defined by the equation (8).

$${r}_{YD} = \frac{{σ}_{y 0} - {σ}_{y 1}}{{σ}_{y 0}} \qquad [ Equation 8 ]$$

where γ_{YD}; decreasing rate of yield stress, σ_{y0}; initial yield stress, σ_{y1}; yield stress after heat treatment

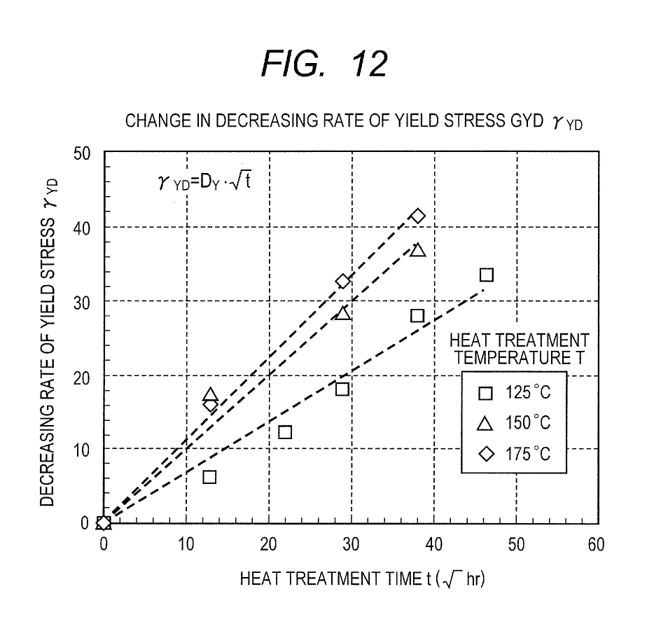

The dependence of the decreasing rate of yield stress (γ_{YD}) on each of the heat treatment temperature and the heat treatment time is shown in FIG. 12. As known from the graph, the decreasing rate of yield stress (γ_{YD}) is increased proportionally to the heat treatment time. Accordingly, the decreasing rate of yield stress (γ_{YD}) was formulated with the equation (9) to study the temperature dependence of a decreasing rate coefficient (D_{y}).

r_{YD}D_{Y}·\sqrt{t} [Equation 9]

where γ_{YD}; decreasing rate of yield stress, D_{y}; decreasing rate coefficient

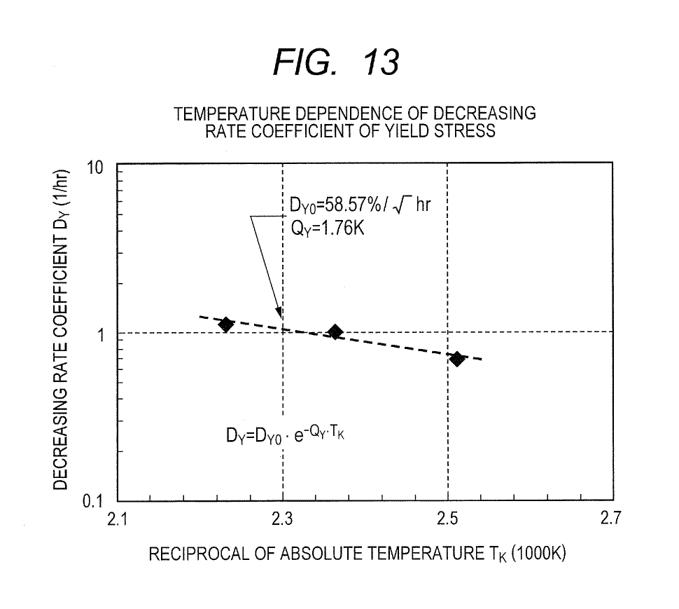

The temperature dependence of the decreasing rate coefficient (D_{y}) is shown in FIG. 13. The points indicated by a black square in the graph represent, from left to right, the decreasing rate coefficients (D_{y}) at the heat treatment temperatures of 175° C., 150° C., and 125° C., respectively.

The decreasing rate coefficient (D_{y}) was formulated with the equation (10) such that the coefficient thereof was determined from the graph. The values of the initial coefficient (D_{y0}) and activation energy (Q_{y}) were described in FIG. 13.

D_{Y}=D_{Y0}·e^{-Q}^{_{Y}}^{·T}^{_{K}} [Equation 10]

where D_{y0}; initial coefficient, Q_{y}; activation energy

The same work was performed by changing the temperature at which the stress-strain diagram was measured. The measured temperatures were set to be −55° C., −15° C., 75° C., and 125° C.

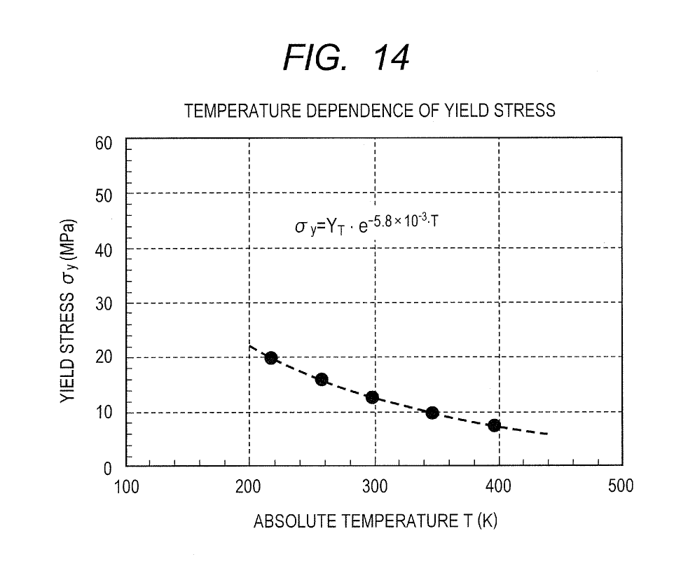

In conjunction with the aforementioned data obtained when the measured temperature is room temperature (23° C.), the results of determining the temperature dependence of the yield stress in the initial state (σ_{Y}) are shown in FIG. 14.

The points indicated by a black circle in FIG. 14 represent, from left to right, the temperature dependences at the measured temperatures of −55° C., −15° C., room temperature (23° C.), 75° C., and 125° C., respectively.

The temperature dependence of the yield stress (σ_{Y}) in FIG. 14 can be formulated with the equation (11).

σ_{y}=Y_{T}·e^{-5.8×10}^{^{−3}}^{·T} [Equation 11]

A yield stress at any heat treatment temperature and after any heat treatment time can be calculated at any measured temperature by using the above formulated equations (6) to (11).

Subsequently, formulation of other physical properties will be described below.

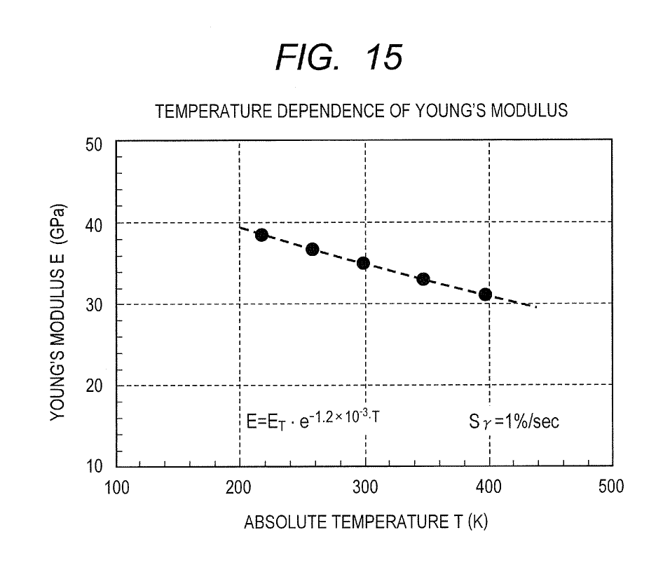

The measured temperature dependence of Young's modulus (E) is shown in FIG. 15. The points indicated by a black circle in the graph represent, from left to right, the measured temperature dependences at the measured temperatures of −55° C., −15° C., room temperature (23° C.), 75° C., and 125° C., respectively.

The measured temperature dependence of Young's modulus (E) was also formulated with the equation (12).

E=E_{T}·e^{-1.2×10}^{^{−3}}^{·T} [Equation 12]

where E; Young's modulus E, _{T}; proportionality coefficient

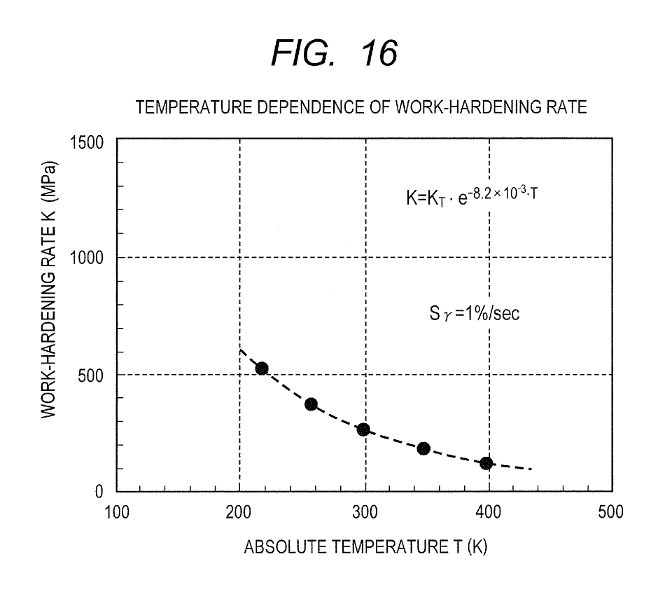

The temperature dependence of a work-hardening rate (K) is shown in FIG. 16. Also, the work-hardening rate (K) was similarly formulated with the equation (13).

K=K_{T}·e^{-8.2×10}^{^{−3}}^{·T} [Equation 13]

where K; work-hardening rate, K_{T}; proportionality coefficient

As stated above, by using the formulated equations (6) to (13), two straight-line approximation of a stress-strain curve at any heat treatment temperature and after any heat treatment time can be obtained at any measured temperature.

### (C) Life Prediction Method (Prediction Method by Change in Solder Physical Property)

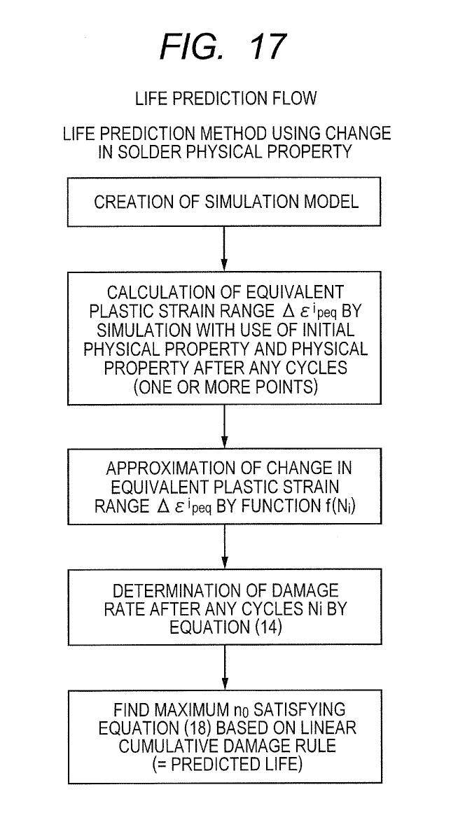

A life prediction flow using a change in the solder physical property is shown in FIG. 17. As known from the view, a simulation model is created and an equivalent plastic strain range Δεⁱ_{peq} is calculated by a simulation with the use of the initial physical property and a physical property after any cycles of the created simulation model. One or more physical properties after any cycles may be enough for the above calculation, and even in the case of one physical property, a plurality of physical properties can be calculated by combining with the initial physical property. It is needless to say that, in the present specification, a process for calculating a strain range by a simulation and a process for predicting the life of an electronic device having a solder joint portion based on either of a change in the physical property of the solder and a change in the fatigue life of the solder joint portion, as stated later, are performed by data processing using a computer device, such as a work station or a personal computer.

Three of A model, B model, and C model are used as simulation models such that the respective equivalent plastic strain ranges of the three models are calculated by simulations.

Subsequently, a change in each of these equivalent plastic strain ranges is approximated by a function equation, and a damage rate is then determined by the equation (14) such that a life prediction is performed by the equation (18) based on a linear cumulative damage rule.

Three models are used in the present embodiment, but the embodiment should not be limited thereto.

Subsequently, a prediction method with the use of a change in a solder physical property will be more specifically described.

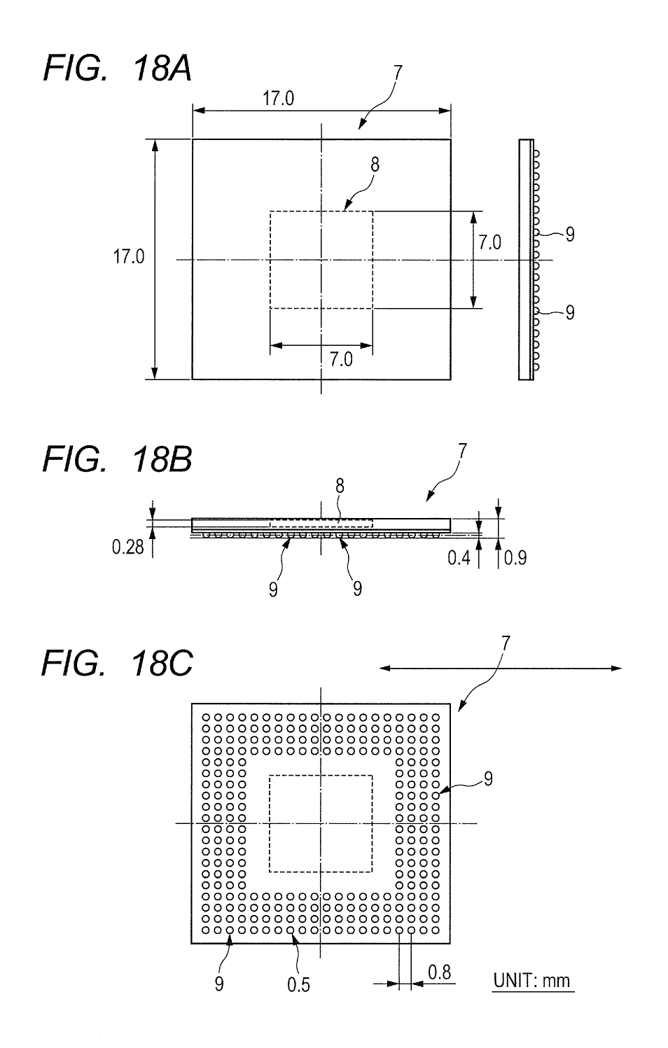

FIGS. 18A to 18C illustrate the outline of a BGA-type semiconductor package 7, which is a simulation analysis model by a finite element method.

The size of the package 7 is 17 mm long×17 mm wide×0.9 mm thick, and solder balls (solder bumps) 9 are arrayed in 4 rows in the periphery of the package 7, which makes the number of pins to be 256 and the ball (bump) pitch to be 0.8 mm. The diameter of the ball (bump) 9 used is 0.5 mm and the coupling height thereof is 0.4 mm.

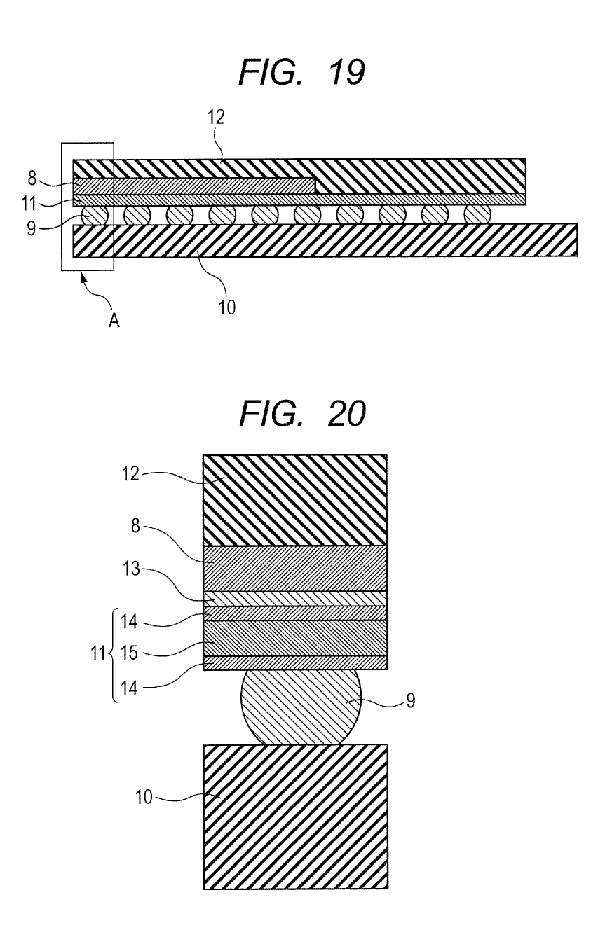

The size of a semiconductor chip 8 to be built in the package 7 is 7 mm long×7 mm wide×0.28 mm thick, and the chip is coupled to a substrate (insulating wiring substrate 11 in FIG. 19) with an adhesive (Ag paste, adhesive 13 in FIG. 20).

This package 7 was mounted on an evaluation board 10 made of a resin by reflow heating.

FIG. 19 is a cross-sectional structure view of a simulation model, the view illustrating part of the cross section in a state where the semiconductor package 7 has been mounted on the evaluation board 10. As known from the view, a plurality of solder balls 9 is provided in a land (not illustrated) on one major surface of the insulating wiring substrate 11 and the semiconductor chip 8 is mounted on the other major surface of the substrate 11, the semiconductor chip (semiconductor element) 8 being covered with a sealing resin 12.

FIG. 20 illustrates an enlarged cross-section of the area A enclosed by a solid line in the simulation model illustrated in Fig. As known from the view, the insulating wiring substrate 11 has a substrate core 15 and substrate resists (resists) 14 provided on both the surfaces (one major surface and the other major surface) of the substrate core 15. The solder balls 9 are provided on the one major surface of the substrate 11 via the non-illustrated land, and the semiconductor chip (semiconductor element/chip) 8 is adhered to the other major surface of the substrate 11 with the adhesive 13.

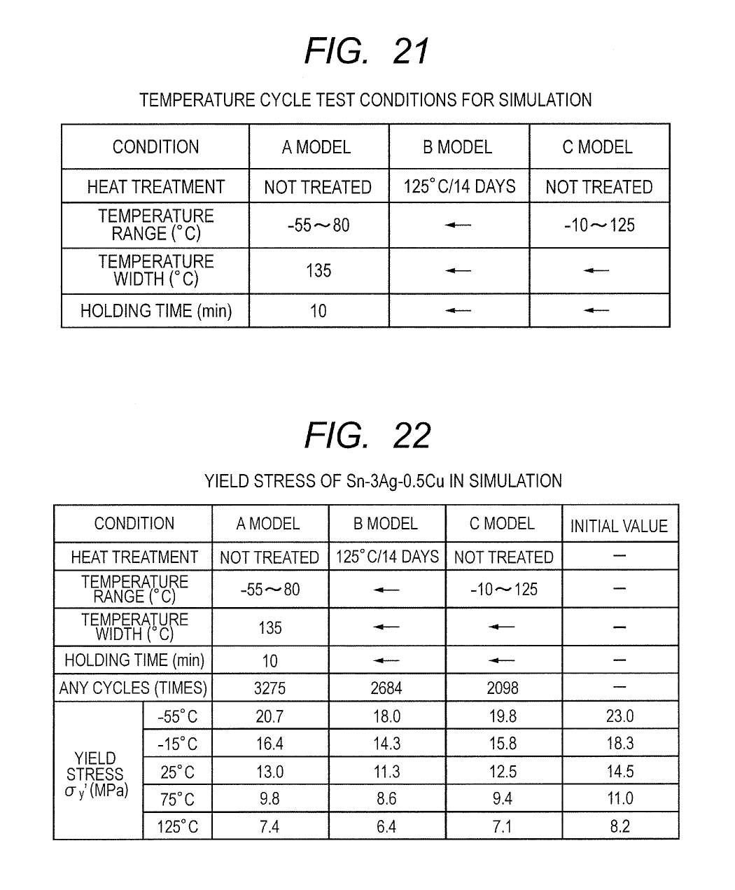

As illustrated in FIG. 21, three of A model, B model, and C model were used as the aforementioned simulation models, and as further known from the view, tests were performed under three different temperature cycle conditions. The left pointing arrow “←” in FIG. 21 means that it is the same as the description in the left column (the same is true in FIGS. 22, 25, and 27).

In the A model, heating was made to be performed within a temperature range of −55 to 80° C. and for a holding time of 10 minutes at each of a high temperature (80° C.) and a low temperature (−55° C.). In the B model, heating was made to be performed, after a heat treatment at 125° C. for 14 days being performed as a pretreatment, within a temperature range of −55 to 80° C. and for a holding time of 10 minutes at each of a high temperature (80° C.) and a low temperature (−55° C.), in the same way as the A model. In the C model, heating was made to be performed within a temperature range of −10 to 125° C. and for a holding time of 10 minutes at each of a high temperature (125° C.) and a low temperature (−10° C.).

The temperature width in each of the temperature cycle test in the three models is 135° C., which is the same as the others.

In the simulation, Sn-3Ag-0.5Cu, a material of the solder ball 9, was made to be an elasto-plastic model, while materials other than that were made to be elastic models.

FIG. 22 shows values of the yield stress (σ_{Y}) of Sn-3Ag-0.5Cu used in the simulation. The values of the yield stress (σ_{Y}) include the initial value (value before the test) and a physical property after any cycles in each model. The yield stress (σ_{Y}) is a value calculated by using the aforementioned equations (6) to (13).

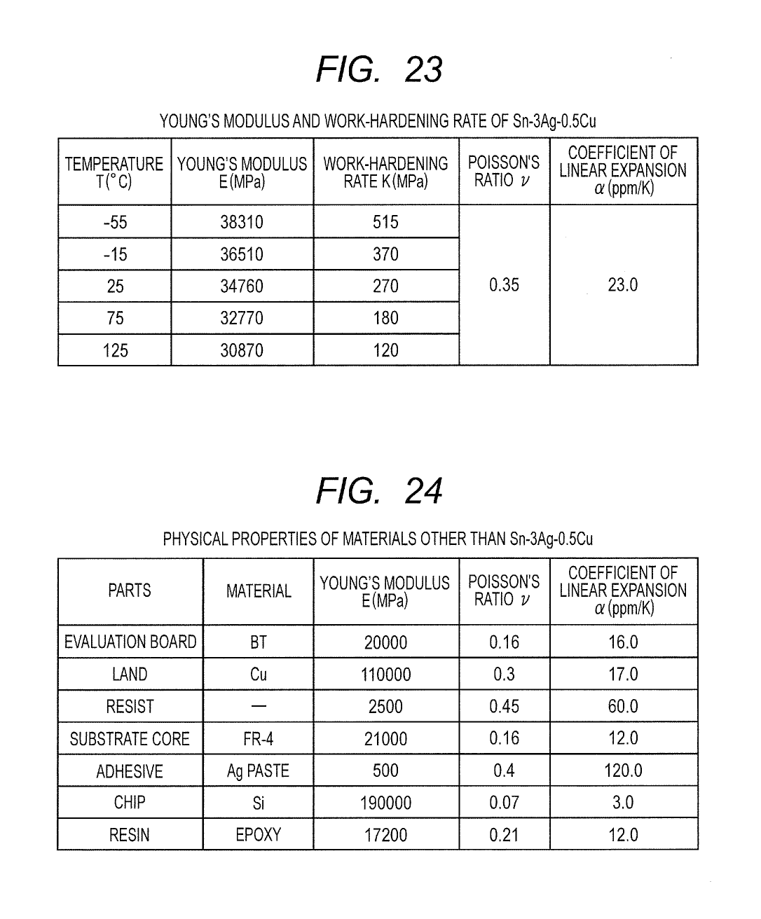

FIG. 23 shows the Young's modulus (E), work-hardening rate (K), Poisson's ratio (ν), and coefficient of linear expansion (α) of Sn-3Ag-0.5Cu, a material of the solder ball 9, other than the yield stress (σ_{Y}). These physical properties are constant without a change between in the initial state and after any cycles.

FIG. 24 shows the physical properties (Young's moduli (E), Poisson's ratios (ν), coefficients of linear expansion (α)) of the materials of the solder ball 9, other than Sn-3Ag-0.5Cu.

A linear cumulative damage rule is used in the life prediction. The yield stress (σ_{Y}) of Sn-3Ag-0.5Cu is changed with the progress in the heat cycle test. This change is incorporated into the equation (1) as a function. A damage rate (1/Nⁱ_{f}) after any temperature cycles (Nᵢ) can be represented by the equation (14). Herein, the superior i of each of “Nⁱ”, “εⁱ”, and “Cⁱ” does not represent a power.

$$\begin{matrix}\frac{1}{{N}_{f}^{i}} = {( {Δɛ}_{peq}^{i} / {C}_{p}^{i} )}^{\frac{1}{{a}_{p}}} \\ = {( f ( {N}_{i} ) / {C}_{p} )}^{\frac{1}{{a}_{p}}} .\end{matrix} \qquad [ Equation 14 ]$$

For example, when the function, f (Nᵢ) in the equation (14) is subjected to straight-line approximation, changes in the respective equivalent plastic strain ranges of the A model, B model, and C model can be approximated by the following functions.

ƒ_{A}(Nᵢ)=2.18×10−6×Nᵢ+1.40×10⁻² [Equation 15]

ƒ_{B}(Nᵢ)=4.06×10⁻⁶×Nᵢ+1.40×10⁻² [Equation 16]

ƒ_{C}(Nᵢ)=4.42×10⁻⁶×Nᵢ+1.71×10⁻² [Equation 17]

A life that should be determined becomes the maximum cycles that satisfy the equation (18) based on the linear cumulative damage rule.

$${\sum }_{i = 1}^{{n}_{o}} \frac{1}{{N}_{f}^{i}} \leq 1 \qquad [ Equation 18 ]$$

The equations (15), (16), and (17) are approximation equations of the changes in the equivalent plastic strain ranges of the A model, B model, and C model, respectively. The results of predicting a life by using both these approximation equations and the damage rate equations (14) and (18) after any cycles Nᵢ are shown in FIG. 28.

Subsequently, models for verification to be used in temperature cycle tests for verification are made to be similar to the three of the A model, B model, and C model used in the aforementioned simulations.

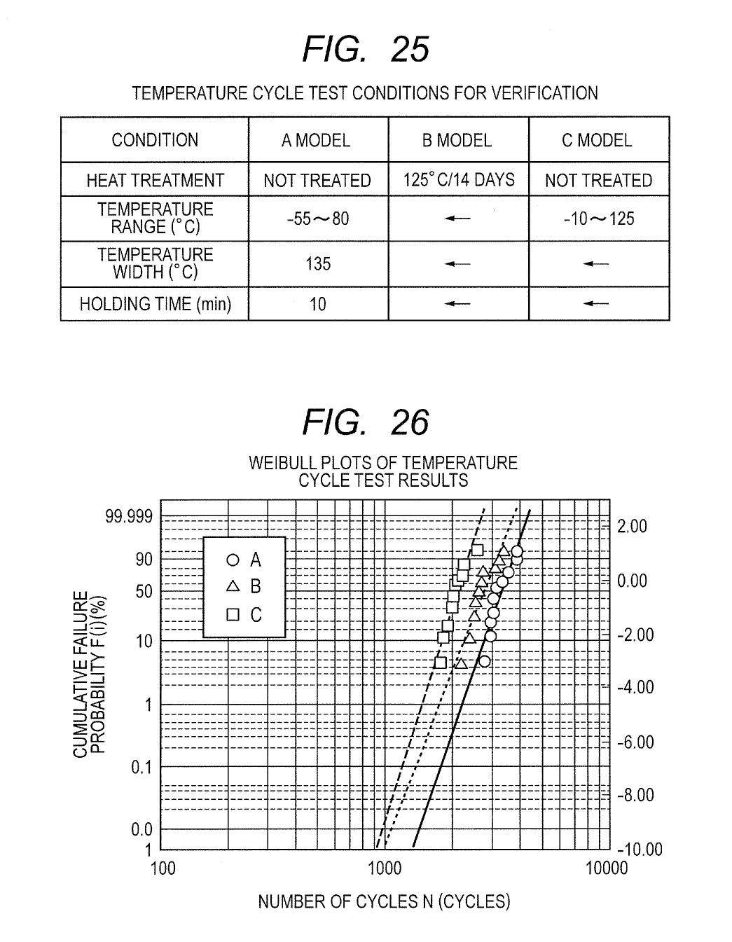

Subsequently, temperature cycle test conditions for verification are shown in FIG. 25. These are the same as the aforementioned conditions in FIG. 21.

FIG. 26 shows Weibull plots of the test results with respect to the three models in FIG. 25. The A model has the longest life, the B model has the second longest life, and the C model has the shortest life.

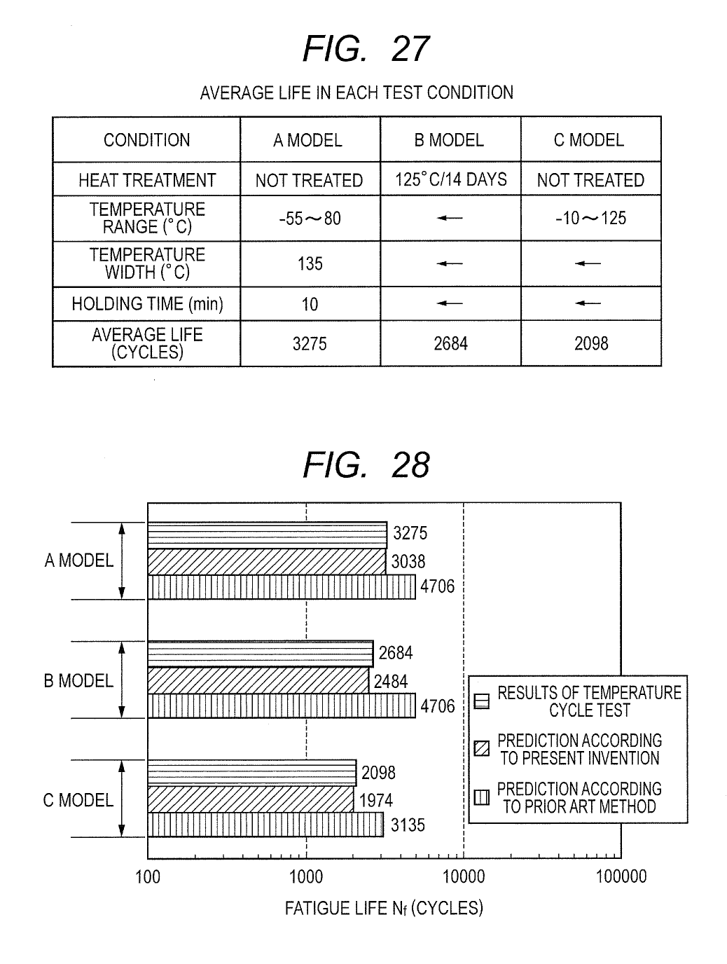

FIG. 27 shows results of calculating the cycle in which cumulative failure rate becomes 50% in the Weibull plot in FIG. 26, i.e., an average life.

Subsequently, the life prediction according to the present embodiment was compared with the results of the temperature cycle tests for verification (average life).

FIG. 28 shows comparisons among the predicted life according to the prediction method in the present embodiment, the result of the aforementioned temperature cycle test for verification, and the predicted life according to a method (related art method) in which the yield stress (σ_{Y}) of Sn-3Ag-0.5Cu is not changed from the initial value.

As known from the view, the result of the comparison shows that the predicted life in each of the A model B model, and C model is closer to the test (experiment) value than that in the related art method.

Because the land area is smaller than that in the test specimen 1 of FIG. 1, the initial fatigue ductility coefficient (C_{P0}) is set to be 0.96, taking into consideration the land area dependence of the fatigue ductility coefficient.

As a result of the comparison in FIG. 28, a life, which is closer to a test (experiment) value than that in a related art method, can be predicted.

### (D) Life Prediction Method (Prediction Method by Change in Fatigue Life)

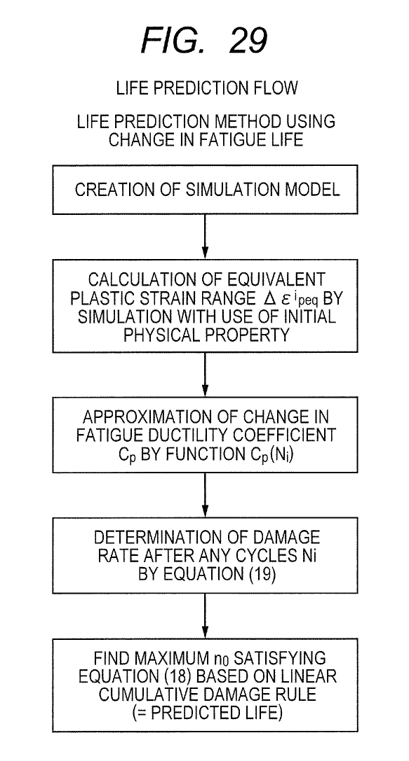

A flow of a life prediction method using a change in a fatigue life is shown in FIG. 29. As known from the view, a simulation model is created and an equivalent plastic strain range is calculated by a simulation with the use of the initial physical property of the created simulation model.

Three of A model, B model, and C model are used as simulation models in the same way as the prediction method by a change in the solder physical property described in (C) such that the respective equivalent plastic strain ranges of the three models are calculated by simulations.

A change in the fatigue ductility coefficient (Cₚ), an element of the equation (1) representing a fatigue life curve, is then approximated by a function equation and a damage rate is determined by the following equation (19) such that life prediction is performed based on the equation (18).

Three models are used in the present embodiment, but the embodiment should not be limited thereto and multiple models may be sufficient.

This life prediction method is different from the life prediction method described in (C) in that the initial physical property value of Sn-3Ag-0.5Cu is used as the physical property thereof in each of the models. By using the equivalent plastic strain range (ΔE_{peq}) calculated by a simulation using the initial physical property value, a damage rate (1/Nⁱ_{f}) after any cycles Nᵢ can be represented by the equation (19). Herein, the superior i of “Nⁱ” does not represent a power.

$$\frac{1}{{N}_{f}^{i}} = {( {Δɛ}_{peq} / {C}_{p} ( {N}_{i} ) )}^{\frac{1}{{a}_{p}}} \qquad [ Equation 19 ]$$

Herein, the fatigue ductility coefficient (Cₚ(Nᵢ)) is approximated by a function. When it is approximated, for example, by an exponential, the fatigue ductility coefficients (Cp(Nᵢ)) in the models can be represented by the following equations, respectively.

C_{pA}(Nᵢ)=0.96×e^{-4.43×10}^{^{−5}}^{×N}^{ᵢ} [Equation 20]

Cₚ(Nᵢ)=0.74×e^{-4.43×10}^{^{−5}}^{×N}^{ᵢ} [Equation 21]

Cₚ(Nᵢ)=0.74×e^{-1.30×10}^{^{−4}}^{×N}^{ᵢ} [Equation 22]

The equations (20), (21), and (22) are approximation equations representing changes in the fatigue ductility coefficients in the A model, B model, and C model, respectively.

Damage rates (1/Nⁱ_{f}) after any temperature cycles Nᵢ are determined from the equation (19) based on the fatigue ductility coefficients determined by these approximation equations such that lives are determined from the equation (18) based on the aforementioned linear cumulative damage rule.

As a result of predicting lives by using the approximation equations and the equation (18) as stated above, the life of the A model became 4119 cycles, that of the B model became 3222 cycles, and that of the C model became 2540 cycles.

The life of each of the models is closer to the actual test result than the life obtained in the related art prediction method shown in FIG. 28.

### (E) Advantage of Life Prediction Method According to Present Embodiment

In each of the prediction methods described in (C) and (D), life prediction with higher accuracy can be performed in comparison with the related art method.

In comparison with the life prediction method using a change in the solder property described in (C), the method using a change in the fatigue life described in (D) is simpler because the number of simulation times is smaller.

In the present embodiment, the life prediction method using a change in the solder property descried in (C) had a predicted value closer to the actual test value (experiment data) than the life prediction method using a change in the fatigue life described in (D). In the case of an element exposed to a high temperature, the physical property and fatigue life thereof are changed. By incorporating either of the changes into life prediction, a technique for accurately predicting the life of a semiconductor device under a high-temperature environment can be established.

The application of electronic devices having solder joint portions, such as semiconductor devices having solder balls, is in progress as in-vehicle devices. With the progress, there is an increasing demand for mounting the electronic device into an engine room where an environmental temperature around the electronic device is approximately 150° C. or higher. Because the electronic device in the engine room is used under a high-temperature environment and for a long period of time, it is necessary to solve the high-temperature tolerance under a high-temperature environment. Also, there is an increasing demand for applying lead-free solder to solder balls due to the Restriction of the use of certain Hazardous Substances. The melting point of the lead-free solder is higher than that of related art solder. That is, the heating temperature in the initial state is higher than that of the related art solder. Also, with respect to electronic devices having solder joint portions, such as the semiconductor devices using lead-free solder balls that can be used under such a high-temperature environment, life prediction with high accuracy can be performed according to the present embodiment. Because the life prediction by a simulation is an essential technique for improving the efficiency in designing semiconductor packages and for speeding up the productization thereof, it is necessary to improve the accuracy of the life prediction.

In particular, in the case of in-vehicle semiconductor devices, the reliability thereof is greatly reduced if the life thereof is shorter than anticipated. However, because life prediction with high accuracy can be performed according to the present embodiment, it never happens that the reliability thereof may be greatly reduced.

### (F) Design Method of Semiconductor Device

Subsequently, a design method of a semiconductor device based on the life prediction method described in (C) or (D) will be described in comparison with a related art design method.

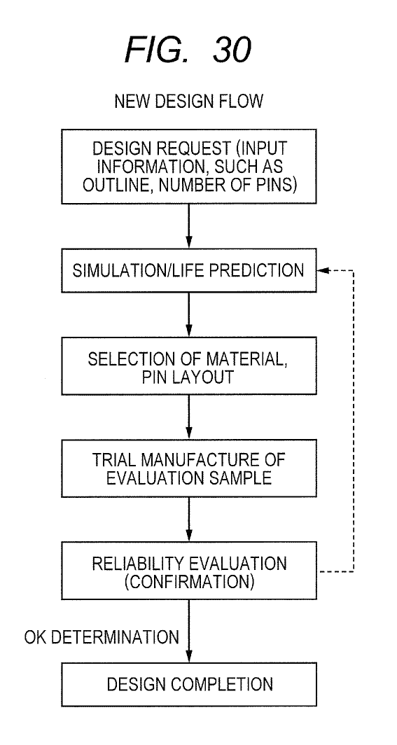

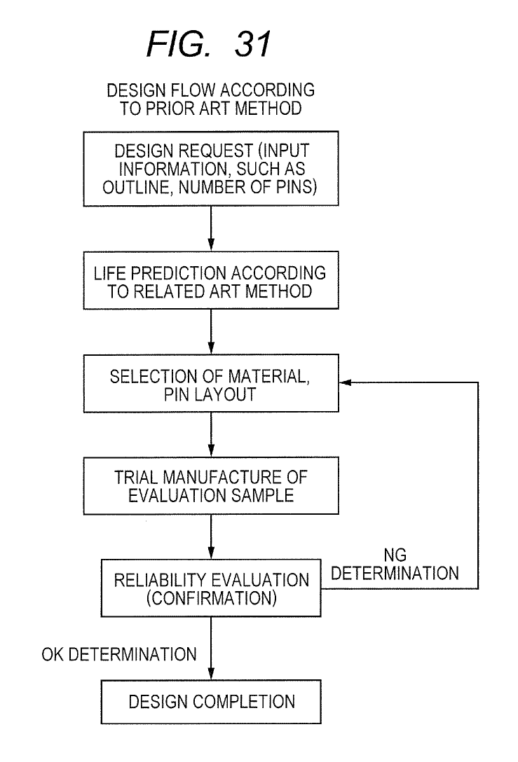

FIG. 30 shows a new design flow according to the present application embodiment, while FIG. 31 shows a related art design flow.

The section of life prediction in the new flow is different from that in the related art flow. Because the life prediction method described in (C) or (D) is used in the new design flow, life prediction accuracy is high and the number of times where NG (No Good) determination (indicated by the dashed-line arrow in FIG. 30) is made in reliability evaluation is reduced, which leads to an improved efficiency in product development. Thereby, productization can be sped up. In particular, in the case of an in-vehicle product, the product must be evaluated for reliability and for a period of time as long as 3 to 6 months, and hence another reliability evaluation results in a great decrease in development efficiency. However, the great decrease in development efficiency can be avoided by the design method according to the present embodiment.

Further, when the products completed according to both the flows are compared with each other, the product according to the new flow can be designed with a larger margin for a development target, because the new design flow has higher prediction accuracy.

The invention made by the present inventors has been specifically described above based on embodiments, but it is needless to say that the invention should not be limited to the embodiments and various modifications can be made without departing from the gist of the invention.

For example, the lead-free solder is not limited to Sn-3Ag-0.5Cu, but other lead-free solders may be used. In addition, the solder bump may be formed of a lead solder.

Further, the present invention can also be applied to: semiconductor devices having solder balls without limiting to the BGA-type semiconductor devices; electronic devices in each of which a semiconductor device, etc., having solder balls has been mounted on a substrate; and electronic devices in each of which a lead-type semiconductor device, such as QFP (Quad Flat Package), has been mounted on a substrate by using solder. The invention can also be applied to semiconductor devices and electronic devices in each of which a material other than solder is used.

The present invention can be applied to a crack extension simulation that is being developed by the company and competitors. In a crack extension simulation as the continuation of a related art technique, material physical properties are the same between the initial state and the final state, and hence a change in the material property (yield stress or fatigue life curve) cannot be taken into consideration, thereby not allowing life prediction with high accuracy to be performed. When the invention is applied to a crack extension simulation, a change in crack extension speed, occurring due to a change in the material property, can be taken into consideration, as well as a change in the crack extension speed, occurring due to a crack shape, thereby allowing crack extension prediction with higher accuracy to be performed.

What is claimed is:

1. A method of predicting the life of an electronic device having a solder joint portion, based on either a change in a physical property of the solder or a change in the fatigue life of the solder joint portion.

2. The method according to claim 1,
wherein the change in a physical property of the solder or the change in the fatigue life of the solder joint portion is determined from the relationship between a heat treatment temperature and a heat treatment time.

3. The method according to claim 2,
wherein the change in a physical property of the solder or the change in the fatigue life of the solder joint portion is formulated to be incorporated into the life prediction.

4. The method according to claim 3,
wherein an equivalent plastic strain range is calculated by using the initial physical property and the physical property after any cycles of a simulation model, and a change in the equivalent plastic strain range is formulated by a function to determine a damage rate, and the life prediction is performed based on these results.

5. The method according to claim 4,
wherein the life prediction is determined by an equation based on a linear cumulative damage rule.

6. The method according to claim 3,
wherein an equivalent plastic strain range is calculated by using the initial physical property of a simulation model, and a change in a fatigue ductility coefficient is approximated by a function to determine a damage rate, and the life prediction is performed based on these results.

7. The method according to claim 6,
wherein the life prediction is determined by an equation based on a linear cumulative damage rule.

8. The method according to claim 5,
wherein the electronic device is a BGA-type semiconductor device.

9. The method according to claim 7,
wherein the electronic device is a BGA-type semiconductor device.

10. A method of designing an electronic device,
wherein the life of the electronic device is predicted based on the life prediction method of an electronic device of claim 5 and the electronic device is designed based on this prediction result.

11. The method according to claim 10,
wherein selection of a material, trial manufacture of an evaluation sample, and reliability evaluation are performed based on the prediction result.

12. A method of designing an electronic device,
wherein the life of the electronic device is predicted based on the life prediction method of an electronic device of claim 7 and the electronic device is designed based on this prediction result.

13. The method according to claim 12,
wherein selection of a material, trial manufacture of an evaluation sample, and reliability evaluation are performed based on the prediction result.
